(19) United States
(12) Patent Application Publication
(10) Pub. No.: US 2022/0234215 A1
(43) Pub. Date: Jul. 28, 2022

(54) INTEGRATED ROBOTIC END EFFECTORS HAVING END OF ARM TOOL GRIPPERS

(71) Applicants: Ford Global Technologies, LLC, Dearborn, MI (US); ABB Inc., Auburn Hills, MI (US)

(72) Inventors: Mark E. Briscoe, Milford, MI (US); Nick Sochacki, Ann Arbor, MI (US); Al Marrocco, Windsor (CA); Arnold Bell, Brighton, MI (US); James Jozwiak, Grand Blanc, MI (US)

(73) Assignees: Ford Global Technologies, LLC, Dearborn, MI (US); ABB Inc., Auburn Hills, MI (US)

(21) Appl. No.: 17/160,762

(22) Filed: Jan. 28, 2021

(51) Int. Cl. B25J 15/00; B25J 15/04; B25J 13/08

(52) U.S. Cl. CPC B25J 15/0042; B25J 13/082; B25J 15/045

(57) ABSTRACT

An end of arm tool (EOAT) for use with a robotic end effector includes radially opposed gripper fingers secured to a distal end portion of the robotic end effector, each radially opposed gripper finger having a recess with a first sidewall and a second sidewall oriented at an acute angle relative to the first sidewall. The radially opposed gripper fingers are configured to translate radially to grip a part within the recesses and to release the part for placement in an assembly.

### CROSS-REFERENCE TO RELATED APPLICATIONS

This application is related to copending applications filed concurrently herewith titled “METHOD AND APPARATUS FOR ASSEMBLING A ROTOR STACK FOR AN ELECTRIC MOTOR,” “METHOD AND APPARATUS FOR TRANSFER MOLDING OF ELECTRIC MOTOR CORES AND MAGNETIZABLE INSERTS,” and “ROTOR ASSEMBLY METHOD AND SYSTEM EMPLOYING CENTRAL MULTI-TASKING ROBOTIC SYSTEM,” which are commonly assigned with the present application and the contents of which are incorporated herein by reference in their entireties.

### FIELD

The present disclosure relates to the manufacture of electric motors, and more particularly to the assembly of rotor cores and magnets for such electric motors.

### BACKGROUND

The statements in this section merely provide background information related to the present disclosure and may not constitute prior art.

With the continuing electrification trend in motor vehicles, related components such as electric motors for electric vehicle powertrains are being developed for high volume production. These electric motors are complex assemblies, typically including a stator and a rotor made up of a plurality of rotor cores with a plurality of magnets disposed in pockets of the rotor cores. Such a construction can be seen, by way of example, in U.S. Publication No. 2018/0287439, which is commonly owned with the present application and the contents of which are incorporated herein by reference in their entirety.

Assembly of these electric motors can be time consuming and challenging given the complexity of the design of the rotor cores and their embedded magnets. Furthermore, electric motor designs vary across different platforms since power requirements for smaller/lighter vehicles are quite different from those of larger/heavy-duty vehicles. For example, the overall size of a rotor (e.g., diameter and height) and the type and number of magnets for an electric motor can vary widely from platform to platform. These variations can result in complex assembly lines with limited flexibility, thus increasing assembly requirements, time, and cost.

These issues related to the assembly of electric motors are addressed by the present disclosure.

### SUMMARY

This section provides a general summary of the disclosure and is not a comprehensive disclosure of its full scope or all of its features.

In one form, an end of arm tool (EOAT) for use with a robotic end effector comprises radially opposed gripper fingers secured to a distal end portion of the robotic end effector, each radially opposed gripper finger comprising a recess having a first sidewall and a second sidewall oriented at an acute angle relative to the first sidewall. The radially opposed gripper fingers are configured to translate radially to grip a part within the recesses and to release the part for placement in an assembly.

In variations of the gripper fingers present disclosure, which may be employed individually or in any combination: each recess further comprises a distal open end; each recess further comprises a proximal end wall; the recesses of the radially opposed gripper fingers together form a triangular opening; the radially opposed gripper fingers are oriented at an angle of 180° relative to each other.

In another form, the EOAT further comprises a first arm and a second arm, wherein a pair of radially opposed gripper fingers are secured to each end of the first arm and the second arm. The EOAT may further comprise a base and a rotational motor, wherein the first arm is fixed to the base and the second arm is secured to the rotational motor such that the second arm is rotationally mounted to the EOAT. In still another variation, the EOAT further comprises a load cell operatively connected to the first arm and the second arm, wherein the load cell provides force feedback from the radially opposed gripper fingers.

In another form, the radially opposed gripper fingers are removably secured to lower arm extensions of the first and second arms. One variation includes a plurality of threaded bolts, wherein each of the radially opposed gripper fingers and the lower arm extensions comprise threaded bores, and the plurality of threaded bolts extend through the threaded bores to secure the radially opposed gripper fingers to the lower arm extensions. In yet another variation, each of the radially opposed gripper fingers comprise at least one construction hole for location of features of the radially opposed gripper fingers.

In another form of the present disclosure, a gripper for use in an end of arm tool (EOAT) for use with a robotic end effector comprises radially opposed gripper fingers, each radially opposed gripper finger comprising a recess having a first sidewall and a second sidewall oriented at an acute angle relative to the first sidewall, wherein the radially opposed gripper fingers are configured to translate radially to grip a part within the recesses and to release the part for placement in an assembly.

In variations of this gripper of present disclosure, which may be employed individually or in any combination: the radially opposed gripper fingers are oriented at an angle of 180° relative to each other; the recesses of the radially opposed gripper fingers together form a triangular opening; each recess further comprises a distal open end; and each recess further comprises a proximal end wall.

In yet another form of the present disclosure, a method of picking parts and placing the parts within an assembly comprises positioning an end of arm tool (EOAT) of a robotic end effector proximate a supply of parts. The EOAT comprises radially opposed gripper fingers secured to a distal end portion of the robotic end effector, each radially opposed gripper finger comprising a recess having a first sidewall and a second sidewall oriented at an acute angle relative to the first sidewall. The method further comprises translating the radially opposed gripper fingers inwardly to grip a part within the recesses, moving the part to a final assembly position, and translating the radially opposed gripper fingers outwardly to release the part.

In variations of this method, which may be employed individually or in any combination, a load cell mounted to the EOAT provides force feedback from the radially opposed gripper fingers; a distance between the radially opposed fingers is measured to determine a size of the part; and a plurality of sets of radially opposed gripper fingers grip, move, and translate a plurality of parts during a common assembly sequence.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of an electric converter to which the teachings of the present disclosure are applied;

FIG. 1B is an exploded view of a rotor core and magnetizable inserts of the electric converter of FIG. 1A;

FIG. 2 is a perspective view an end of arm tool (EOAT) for use with a robotic end effector and having radially opposed gripper fingers constructed according to the teachings of the present disclosure;

FIG. 3A is a perspective view illustrating gripper fingers constructed according to the teachings of the present disclosure;

FIG. 3B is another perspective view of the gripper fingers of FIG. 3A;

FIG. 4A is a perspective view illustrating one radially opposed gripper finger of FIG. 3A; and

FIG. 4B is a perspective view illustrating the other radially opposed gripper finger of FIG. 3A;

FIG. 5 is a bottom view of the EOAT of FIG. 2 with the radially opposed gripper fingers in an open position;

FIG. 6 is a bottom view of the EOAT of FIG. 2 with the radially opposed gripper fingers in a closed position;

FIG. 7 is a perspective view of the EOAT of FIG. 2 with a second arm in a rotated position; and

FIG. 8 is a bottom view of the rotated second arm of FIG. 7.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

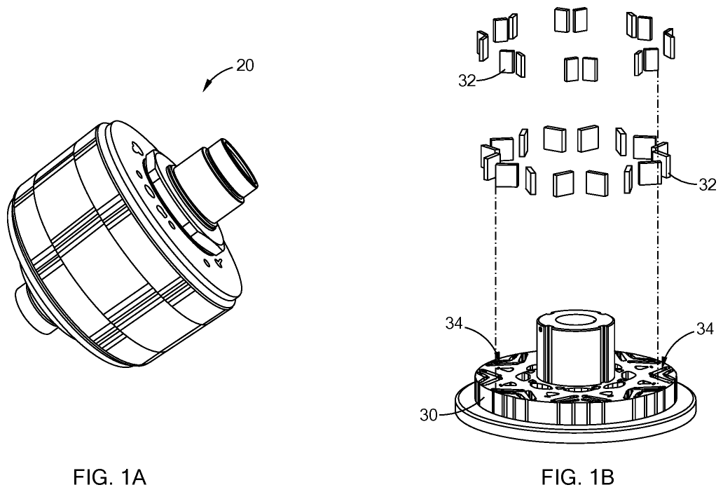

Referring to FIGS. 1A and 1B, an electric motor to which the teachings of the present disclosure are applied is illustrated and generally indicated by reference numeral 20. The electric motor 20 generally includes a plurality of rotor cores 30 (only one shown in FIG. 1B for purposes of clarity) and a plurality of magnetizable inserts 32 disposed within cavities 34 of the rotor cores 30. As set forth above, construction of such an electric motor 20 is described in greater detail in U.S. Publication No. 2018/0287439, which has been incorporated herein by reference in its entirety. Advantageously, the present disclosure provides an innovative and efficient method and a related apparatus for picking and placing the magnetizable inserts 32 within the cavities 34 of the rotor cores 30.

While the present disclosure is directed to electric motors, it should be understood that the teachings herein may be applied to other electric/electricity converters such as generators, in addition to other parts/assemblies for a variety of applications that involve placing parts into, onto, or proximate an assembly. Accordingly, the illustration of an electric motor 20 and its specific assembly method should not be construed as limiting the scope of the present disclosure.

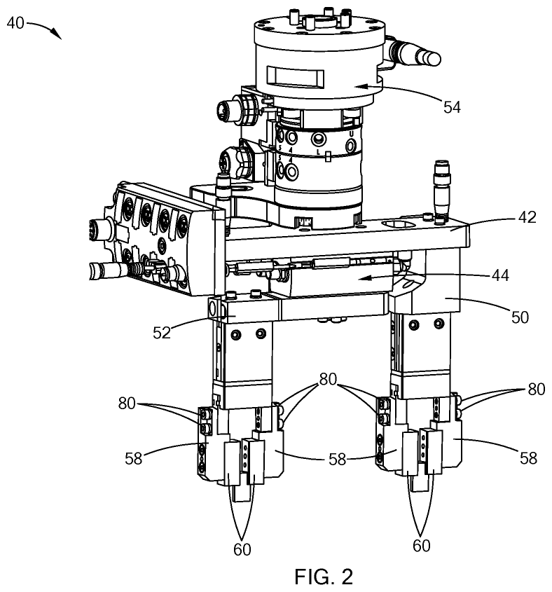

Referring to FIG. 2, an end of arm tool (EOAT) for use with a robotic end effector (not shown) is illustrated and generally indicated by reference numeral 40. Among other components, the EOAT 40 comprises a base 42 and a rotational motor 44 secured to the base 42. In this form, a first arm 50 is fixed to the base 42, and a second arm 52 is secured to the rotational motor 44 such that the second arm 52 is rotationally mounted to the EOAT 40. The EOAT 40 further comprises a load cell 54 operatively connected to the first arm 50 and the second arm 52, wherein the load cell 54 provides force feedback from radially opposed gripper fingers 60. Further details of the EOAT and its operation are illustrated and described in copending application titled “METHOD AND SYSTEM FOR ASSEMBLING A ROTOR STACK FOR AN ELECTRIC MOTOR,” which is commonly owned with the present application and the contents of which are incorporated herein by reference in their entirety.

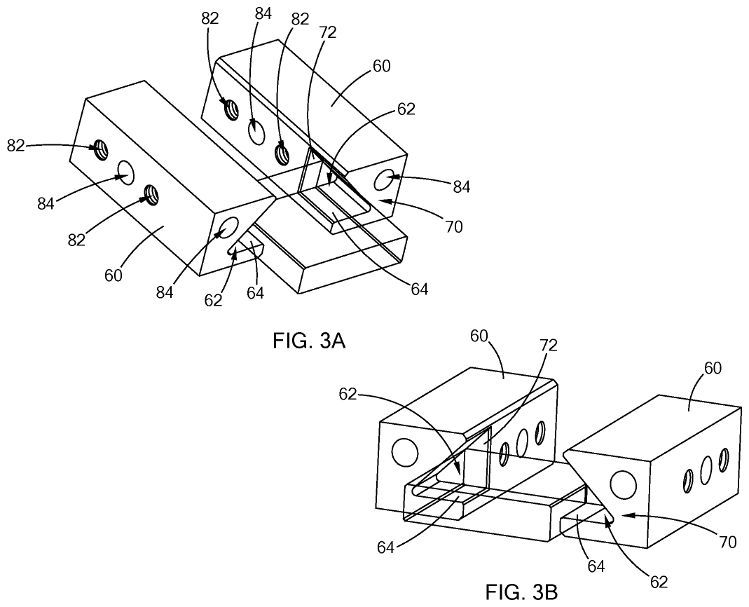

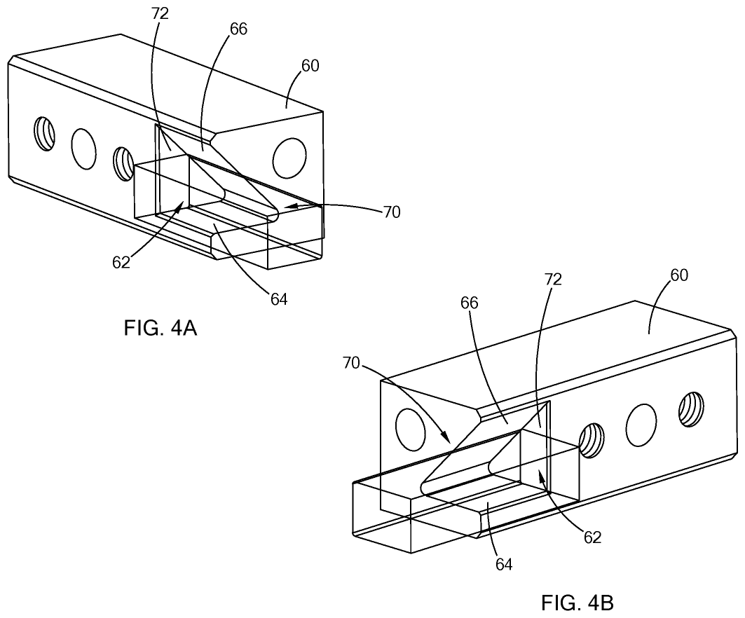

Referring also to FIGS. 3A-3B and 4A—4B, a pair of the radially opposed gripper fingers 60 are secured to each end of the first arm 50 and the second arm 52. Each radially opposed gripper finger 60 comprises a recess 62 having a first sidewall 64 and a second sidewall 66 (shown best in FIGS. 4A-4B) oriented at an acute angle relative to the first sidewall 64. In this form, the recesses 62 of the radially opposed gripper fingers 60 together form a triangular opening. As further shown, each recess 62 further comprises a distal open end 70 and a proximal end wall 72.

Referring back to FIG. 2, in one form of the present disclosure, the radially opposed gripper fingers 60 are removably secured to lower arm extensions 58 of the first and second arms 50/52. In one form, a plurality of threaded bolts 80 extend through threaded bores 82 (FIG. 3A) of the lower arm extensions 58 to removably secure the gripper fingers 60 to the lower arm extensions 58. It should be understood, however, that other means to secure the gripper fingers 60 may be employed while remaining within the scope of the present disclosure. As further shown in FIG. 3A, each of the radially opposed gripper fingers 60 may optionally include at least one construction hole 84 for location of features of the radially opposed gripper fingers 60.

In operation, the first sidewall 64 and the second sidewall 66 of each radially opposed gripper finger 60 cooperate with the opposed sidewalls of the radially opposed gripper finger 60 to grab or “pick” a part and place the part within an assembly, such as the magnetizable insert 32 in the electric motor 20 as shown above.

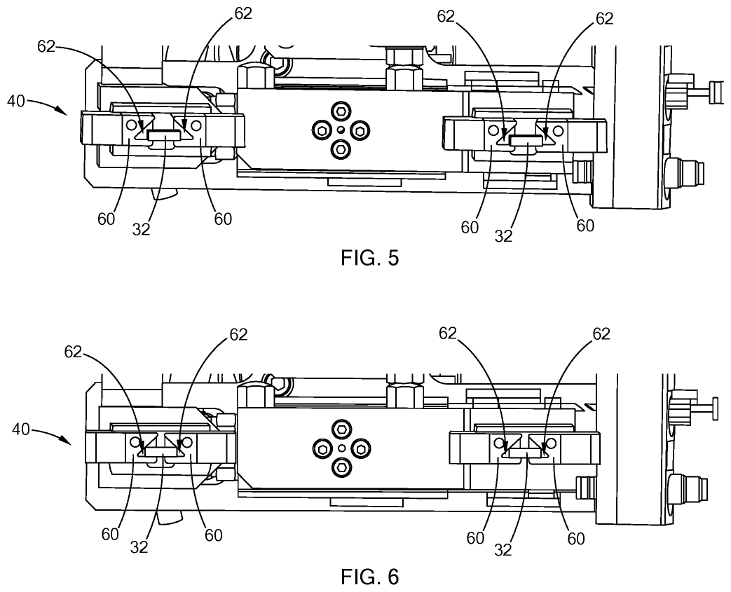

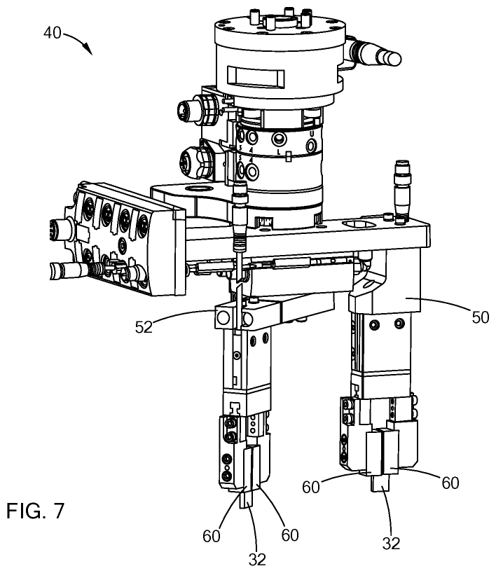

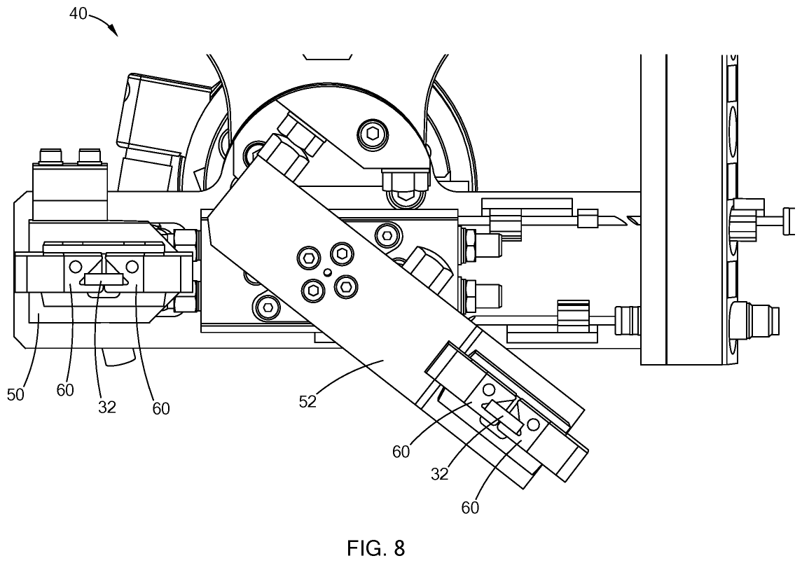

More specifically, and with reference to FIGS. 5-8, the radially opposed gripper fingers 60 are configured to translate radially to grip a part (e.g., magnetizable insert 32) within the recesses 62 and to release the part for placement in an assembly (e.g., electric motor 20). The EOAT 40 is positioned near a supply of parts (such as the cartridge feeders as described in copending application “METHOD AND SYSTEM FOR ASSEMBLING A ROTOR STACK FOR AN ELECTRIC MOTOR,” as set forth above). The radially opposed gripper fingers 60 are translated inwardly to grip the part 32 within the recesses 62 (FIG. 6). The part 32 is then moved to a final assembly position. The final assembly position for the electric motor 20 set forth herein includes placing the first arm 50 proximate an insertion location for its respective part being gripped and rotating the second arm 52 proximate an insertion/placement location for its respective part being gripped. The radially opposed gripper fingers 40 are then translated outwardly to release the part 32.

In this form, the radially opposed gripper fingers 60 are oriented at an angle of 180° relative to each other as shown. However, it should be understood that a wide variety of orientations of the radially opposed gripper fingers 60 relative to each other, as well as geometries for the recesses 62, other those illustrated herein may be employed while remaining within the scope of the present disclosure.

In one form of the present disclosure, the load cells 54/56 mounted to the first arm 50 and the second arm 52 provide force feedback from the radially opposed gripper fingers 60. Operation of the force feedback is described in greater detail in copending application titled “METHOD AND SYSTEM FOR ASSEMBLING A ROTOR STACK FOR AN ELECTRIC MOTOR,” set forth above.

In another variation of the present disclosure, a distance between the radially opposed fingers 60 is measured to determine a size of the part 32. For example, an analog switch in communication with a cylinder of a linear actuator (not shown) can be used to indicate a position of the radially opposed fingers 60 and thus the size of the part 32.

In still another form the EOAT 40 may employ a plurality of sets of radially opposed gripper fingers 60 to grip, move, and translate a plurality of parts 32 during a common assembly sequence. Further, any number of EOATs 40 may be implemented with one or more pairs of radially opposed gripper fingers 60 while remaining within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. For example, while the disclosure is directed to electric motors, it should be understood that the teachings of the present disclosure may be applied to other electric/electricity converters such as generators. Further, while two arms (50/52) are illustrated and described, it should be understood that the EOAT may comprising any number of arms, i.e., more than two, while remaining within the scope of the present disclosure. Similarly, a plurality of components may be employed rather than individual components as illustrated and described herein. Such variations are not to be regarded as a departure from the spirit and scope of the disclosure.

What is claimed is:

1. An end of arm tool (EOAT) for use with a robotic end effector, the EOAT comprising:
radially opposed gripper fingers secured to a distal end portion of the robotic end effector, each radially opposed gripper finger comprising a recess having a first sidewall and a second sidewall oriented at an acute angle relative to the first sidewall,
wherein the radially opposed gripper fingers are configured to translate radially to grip a part within the recesses and to release the part for placement in an assembly.

2. The EOAT according to claim 1, wherein each recess further comprises a distal open end.

3. The EOAT according to claim 1, wherein each recess further comprises a proximal end wall.

4. The EOAT according to claim 1, wherein the recesses of the radially opposed gripper fingers together form a triangular opening.

5. The EOAT according to claim 1, wherein the radially opposed gripper fingers are oriented at an angle of 180° relative to each other.

6. The EOAT according to claim 1, further comprising:
a first arm; and
a second arm,
wherein a pair of radially opposed gripper fingers are secured to each end of the first arm and the second arm.

7. The EOAT according to claim 6, further comprising:
a base; and
a rotational motor,
wherein the first arm is fixed to the base and the second arm is secured to the rotational motor such that the second arm is rotationally mounted to the EOAT.

8. The EOAT according to claim 6, further comprising a cell operatively connected to the first arm and the second arm, wherein the load cell provides force feedback from the radially opposed gripper fingers.

9. The EOAT according to claim 6, wherein the radially opposed gripper fingers are removably secured to lower arm extensions of the first and second arms.

10. The EOAT according to claim 9 further comprising a plurality of threaded bolts, wherein each of the radially opposed gripper fingers and the lower arm extensions comprise threaded bores, and the plurality of threaded bolts extend through the threaded bores to secure the radially opposed gripper fingers to the lower arm extensions.

11. The EOAT according to claim 1, wherein each of the radially opposed gripper fingers comprise at least one construction hole for location of features of the radially opposed gripper fingers.

12. A gripper for use in an end of arm tool (EOAT) for use with a robotic end effector, the gripper comprising:
radially opposed gripper fingers, each radially opposed gripper finger comprising a recess having a first sidewall and a second sidewall oriented at an acute angle relative to the first sidewall,
wherein the radially opposed gripper fingers are configured to translate radially to grip a part within the recesses and to release the part for placement in an assembly.

13. The gripper according to claim 12, wherein the radially opposed gripper fingers are oriented at an angle of 180° relative to each other.

14. The gripper according to claim 12, wherein the radially opposed gripper fingers together form a triangular opening.

15. The gripper according to claim 12, wherein each recess further comprises a distal open end.

16. The gripper according to claim 12, wherein each recess further comprises a proximal end wall.

17. A method of picking parts and placing the parts within an assembly, the method comprising:
positioning an end of arm tool (EOAT) of a robotic end effector proximate a supply of parts, the EOAT comprising:
radially opposed gripper fingers secured to a distal end portion of the robotic end effector, each radially opposed gripper finger comprising a recess having a first sidewall and a second sidewall oriented at an acute angle relative to the first sidewall;
translating the radially opposed gripper fingers inwardly to grip a part within the recesses;
moving the part to a final assembly position; and
translating the radially opposed gripper fingers outwardly to release the part.

18. The method according to claim 17, wherein a load cell mounted to the EOAT provides force feedback from the radially opposed gripper fingers.

19. The method according to claim 18, wherein a distance between the radially opposed fingers is measured to determine a size of the part.

20. The method according to claim 17 further comprising a plurality of sets of radially opposed gripper fingers to grip, move, and translate a plurality of parts during a common assembly sequence.
